(19) United States
(12) Patent Application Publication
(10) Pub. No.: US 2010/0043170 A1
(43) Pub. Date: Feb. 25, 2010

(54) DUST SEPARATING DEVICE OF A CLEANER

(75) Inventor: Zugen Ni, Suzhou (CN)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Kingclean Electric Co., Ltd., Jiangsu (CN)

(21) Appl. No.: 12/518,395

(22) PCT Filed: Dec. 24, 2007
(86) PCT No.: PCT/CN07/03758

§ 371 Date: Jun. 9, 2009

(30) Foreign Application Priority Data
Mar. 8, 2007 (CN) 200710020226.8
Mar. 29, 2007 (CN) 200720036551.9

(51) Int. Cl. A47L 9/20; B01D 50/00

(52) U.S. Cl. 15/352; 55/324

(57) ABSTRACT

A dust separating device of a vacuum cleaner includes a first dust separator (1, 1′) and a second dust separator (2, 2′). The axis of the first separating unit (101, 101′) of the first dust separator (1, 1′) is arranged perpendicular to the axes of the second separating units (201, 201′) of the second dust separator (2, 2′). The first separating unit (101, 101′) of the first dust separator (1, 1′) is communicated with a dust cup (103, 103′) via a dust outlet (102, 102′)′ and is located outside of the dust cup (103, 103′).

### FIELD OF INVENTION

The present invention relates to a dust separating device of a vacuum cleaner.

### BACKGROUND OF THE INVENTION

Conventional vacuum cleaners are provided with filter, in order to filter the dusty air sucked in with the dust left in the dust collecting device. Therefore, after being used for a while, the filter needs cleaning or replacing. Otherwise, if fine dust clogs the holes of the filter, the resistance of the vacuum motor will increase so that the vacuum motor will be burned out in serious condition. This will bring troubles to the users and affect the performance and the life of the vacuum cleaners.

Recently, according to the principle of cyclone separation, some vacuum cleaner manufacturers use a cyclone separator to replace the filter and achieve favorable dedusting results, thereby this is widely used in vacuum cleaners. The cyclone separator is usually provided with a cyclone body of an inverted cone in a dust cup. The cyclone body is provided vertically with an air outlet pipe on the top end and is connected to the air outlet of dust cup thereof. The cyclone is also provided with an opening at the bottom for dust falling into the dust collecting case at the bottom of the dust cup. The air inlet pipe is provided on the side wall of the upper portion of the cyclone body and along the tangential direction, and it is connected to the cyclone body, so that air flow carrying dust is introduced into the cyclone body and generates cyclone. Dust will fall along the side wall of the cyclone body into the bottom of the dust collecting case under centrifugal force. After being dedusted, the air flow is discharged out of the dust cup upwards through the air outlet pipe.

With user's reinforcement of the environment protection consciousness, the vacuum cleaners are required to discharge cleaner air therefrom and to avoid secondary pollution. Therefore, the vacuum cleaners in the market have two stages of dust separators, within which the first stage of dust separator could be a filter chamber or cyclone body, and the second stage of dust separator is a cyclone body. Although the two stages of dust separators are different in shape and have a dust collecting chamber in common or respectively have dust collecting chambers, the configuration of the two stages of dust separators is always a front-rear or up-down configuration (for example, as shown in Chinese Patent Publication No. CN1729924). Furthermore, the dust-flow-out direction of the first stage coincides with the air-flow-out direction after dedusting, which causes the efficiency of the first stage of dust separator can't be improved, thereby affecting the dedusting efficiency of the whole vacuum cleaner. Additionally, the dedusters of the first stage of dust separator are all located inside the dust cup, thereby affecting the volume of the dust cup and increasing the frequency of cleaning the dust cup by the users.

### SUMMARY OF THE INVENTION

The object of the present invention is to provide a dust separating device of a vacuum cleaner, in which an angle exists between the axis of the first dust separator and the axis of the second dust separator, thereby avoiding the influences of the dust-flow-out direction of the first stage of dust separator and the air-flow-out direction on each other. This will improve the filtering efficiency while the first stage of dust separator could be configured outside of the dust cup, thereby increasing the volume of the dust cup and decreasing the frequency of cleaning the dust cup by the users.

The first aspect of the present invention is to provide a dust separating device of a vacuum cleaner comprising: a first dust separator and a second dust separator located downstream from the first dust separator, the second dust separator comprising a plurality of second separating units parallel to each other, characterized in that there exists an angle between the axis of the first separating unit of the first dust separator and the axes of said second separating units of the second dust separator.

Preferably, the first separating unit of the first dust separator is connected to a dust cup via a dust outlet and is located outside of the dust cup.

Furthermore, said first separating unit is provided horizontally above the dust cup, and said second separating units are provided perpendicularly adjacent to said dust cup.

Additionally, said first separating unit comprises a cyclone body, whose interior is divided into a cyclone chamber on the right and an flow chamber on the left by a removable cyclone separator. The cyclone separator has an opening on the right end thereof and a conical filter full of grid on the left end thereof which is positioned in said cyclone chamber. An air inlet connected to an inflow pipe of the vacuum cleaner is provided on the side wall of the cyclone body corresponding to the conical filter. Said dust outlet connected to the dust cup is provided on the right end of said cyclone chamber. A first air outlet connected to the second separating units is provided on the flow chamber.

Still preferably, each said second separating unit comprises an upper portion of cylinder body and a lower portion of conical body. A second dust collector of the second dust separator is arranged below said conical body. A second air inlet is connected to the side wall of the cylinder body. A second air outlet is provided coaxially in said cylinder body and is connected to an outflow pipe. An umbrella-shaped reflecting disc is provided in the connecting portion of the conical body and the second dust collector. An annular gap for allowing falling dust to pass therethrough is provided along the periphery of said umbrella-shaped reflecting disc and the umbrella-shaped reflecting disc defines a hole for returning air in the center portion thereof.

Still furthermore, a connecting chamber is provided between the first separating unit and the second separating units. The connecting chamber is located below said first separating unit and above the second separating units. The first air outlet is connected to the connecting chamber. The cylinder body protrudes upward into the connecting chamber, thereby connecting second air inlets with the first air outlet.

The second aspect of the present invention is to provide a dust separating device of a vacuum cleaner comprising: a removable first dust separator and a second dust separator located below and downstream from the first dust separator. The first dust separator comprises a first separating unit arranged horizontally. The second dust separator comprises a plurality of second separating units arranged perpendicularly, a plurality of second dust collectors located below the corresponding second separating units, and a dust cup for collecting dust separated by the first separating unit.

Preferably, the first dust separator further comprises a first air inlet connected to the first separating unit at one end thereof, a first air outlet adjacent to the first air inlet, a dust outlet connected to the first separating unit at the other end thereof, and a connecting chamber connected to the first air outlet and dividing the air flow into a plurality of small air flows to be introduced into the corresponding second separating units.

Furthermore, the first dust separator further comprises an inflow pipe which is located at one end thereof and is connected to the first air inlet, an outflow pipe located at the other end thereof for discharging air flow which has been dedusted and separated by the first and second dust separators, and a plurality of second air outlets located below the dust separator and inserted into the corresponding second separating units as well as connected to the outflow pipe.

Additionally, the horizontal length of the first dust separator is larger than the perpendicular height of the second dust separator.

The third aspect of the present invention is to provide a dust separating device of a cleaner, the dust separating device comprises: a first dust separator and a second dust separator located below the first dust separator. The first dust separator comprises a first separating unit arranged in a first direction. The second dust separator comprises a plurality of second separating units parallel to each other and arranged in a second direction.

Preferably, the horizontal length of the first dust separator is smaller than the perpendicular height of the second dust separator.

Furthermore, there exists an angle between the first direction and the second direction. Said angle is a right angle.

Still preferably, the first dust separator comprises an inflow pipe for introducing dusty air flow and an outflow pipe for discharging air flow which has been dedusted and separated by the first and second dust separators.

Still furthermore, the inflow pipe is located above the outflow pipe, and both pipes are arranged at the same side of the first separating unit.

The fourth aspect of the present invention is to provide a dust separating device of a vacuum cleaner comprising: a first dust separator comprising a first separating unit; a second dust separator with its two ends open and located downstream from said first dust separator, said second dust separator comprising a plurality of second separating units parallel to each other, a plurality of second dust collectors arranged corresponding to respective second separating units, and a dust cup for collecting dust separated by first separating unit; and a spacer located between the first dust separator and the second dust separator for dividing the air flow out from the first dust separator into a plurality of small flows to be introduced into corresponding second separating units; wherein the first dust separator closes/opens the opening at one end of the second dust separator.

Preferably, the dust separating device further comprises a bottom cover for closing/opening the opening at the other end of the second dust separator so that the dust in the dust collectors and the dust cup could be cleaned up simultaneously.

Furthermore, parts of the outside surface of the second separating units form the periphery of the dust cup, and the remain parts of the outside surface form the periphery of the second dust separator.

Additionally, each dust collector is integrated below the corresponding second separating unit.

The advantages of the present invention are as follows:

1. There exists an angle between the axis of the first dust separator and the axis of the second dust separator, especially a right angle, thereby avoiding the influences of the dust-flow-out direction of the first dust separator and the air-flow-out direction on each other and improving the deducting efficiency of the vacuum cleaner.

2. The separating unit of the first dust separator is located outside of the dust cup, thereby increasing the volume of dust cup and decreasing the frequency of cleaning the dust cup by the users.

3. The dust cup of the first separating unit shares one bottom cover with the dust collectors of the second separating unit, so after opening the bottom cover, the user can concurrently dump dust from the dust collectors and the dust cup.

### BRIEF DESCRIPTION OF THE DRAWINGS

With reference to the description combined with the accompanying drawings, the structure and operation as well as its further objects and advantages will be best envisaged. The same reference number represents the same parts.

FIG. 1 is a perspective view of the vacuum cleaner having a dust separating device according to the first exemplary embodiment of the present invention;

FIG. 2 is an exploded perspective view of the dust separating device according to the first exemplary embodiment of the present invention;

FIG. 3 is a top view of the dust separating device according to the first exemplary embodiment of the present invention;

FIG. 4 is a cross-sectional view of the dust separating device according to the first exemplary embodiment of the present invention, taken along line A-A of FIG. 3;

FIG. 5 is a cross-sectional view of the dust separating device according to the first exemplary embodiment of the present invention, taken along line B-B of FIG. 3;

FIG. 6 is a cross-sectional view of the dust separating device according to the first exemplary embodiment of the present invention, taken along line C-C of FIG. 3;

FIG. 7 is a cross-sectional view of the dust separating device according to the first exemplary embodiment of the present invention, taken along line D-D of FIG. 3;

FIG. 8 is a cross-sectional view of the dust separating device according to the first exemplary embodiment of the present invention, taken along line E-E of FIG. 6;

FIG. 9 is a perspective view of the dust separating device according to the second exemplary embodiment of the present invention;

FIG. 10 is a perspective view of the dust separating device as shown in FIG. 9, seen from another direction;

FIG. 11 is an exploded perspective view of the dust separating device as shown in FIG. 9;

FIG. 12 is a top view of the dust separating device as shown in FIG. 9;

FIG. 13 is a cross-sectional view of the dust separating device according to the second exemplary embodiment of the present invention, taken along line A-A of FIG. 12; and

FIG. 14 is a cross-sectional view of the dust separating device according to the second exemplary embodiment of the present invention, taken along line B-B of FIG. 12.

List of the reference numbers:

1, 1′: first dust separator;
101, 101′: first separating unit;
102, 102′: dust outlet;
103, 103′: dust cup;
104, 104′: cyclone body;
105, 105′: base plate;
106, 106′: cyclone chamber;
107, 107′: flow chamber;
108, 108′: opening;
109, 109′: cyclone separator;
110, 110′: first air inlet;
111, 111′: first air outlet;
112, 112′: cylindrical portion;
113, 113′: conical filter;
114, 114′: bottom cover;
115′: cone;
2, 2′: second dust separator;
201, 201′: second separating unit;
202, 202′: cylinder body;
203, 203′: conical body;
204, 204′: dust collector;
205, 205′: second air inlets
206, 206′: second air outlet;
207, 207′: umbrella-shaped reflecting disc;
208, 208′: annular gap;
209, 209′: hole;
3, 3′: inflow pipe;
4, 4′: outflow pipe;
5, 5′: connecting chamber;
6, 6′: spacer.

### DETAILED DESCRIPTION OF THE PREFERRED EMBODIMENT

Although this invention may be applied to embodiments of different types and variations, only two of them will be shown in the accompanying drawings and described in details hereinafter. It could be understood that this invention is disclosed by way of illustration of an example. The disclosure will not limit the invention to the foregoing embodiments and description thereof.

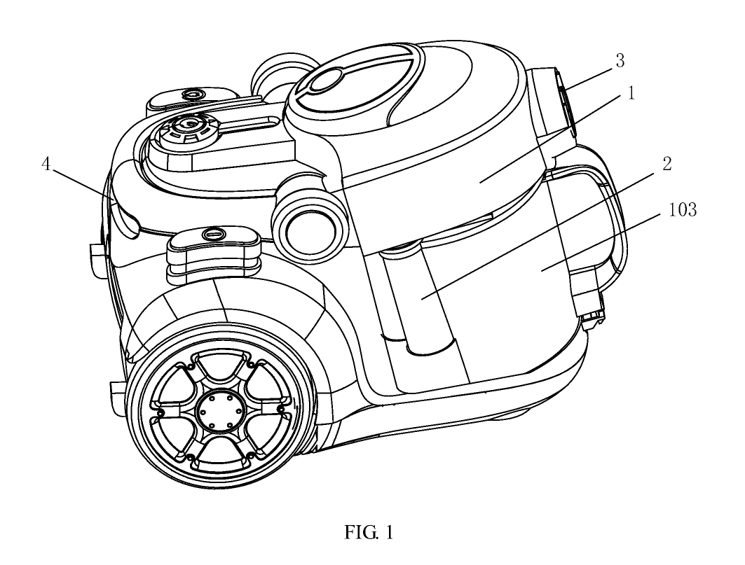

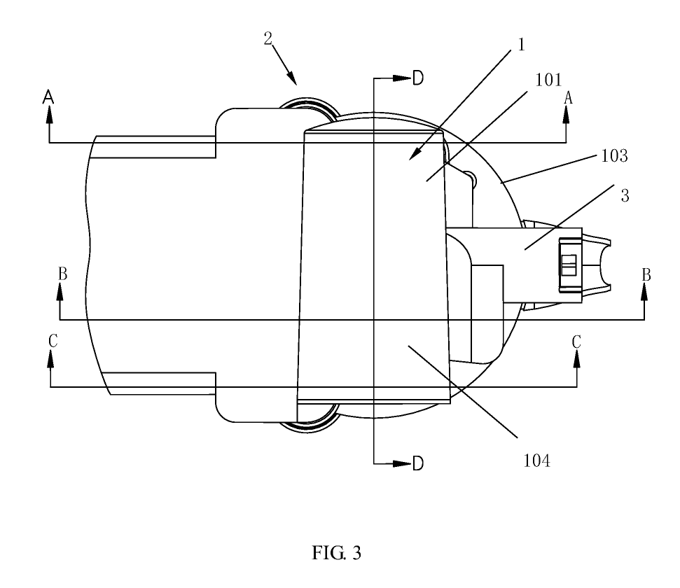

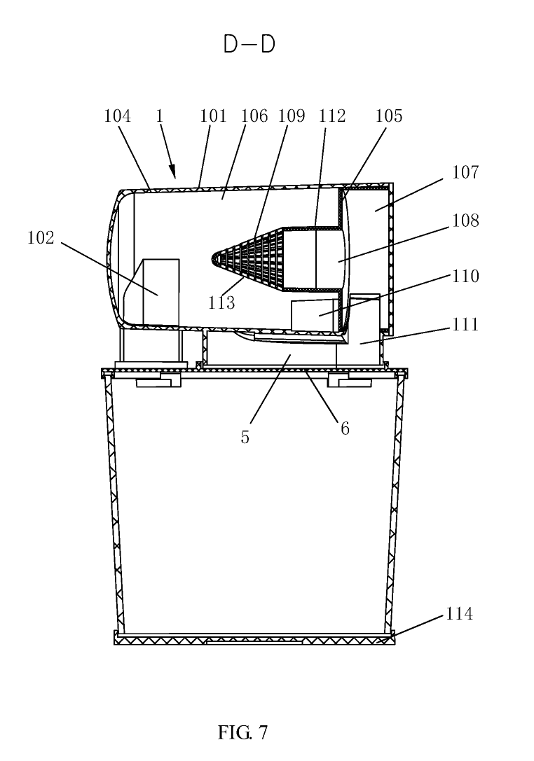

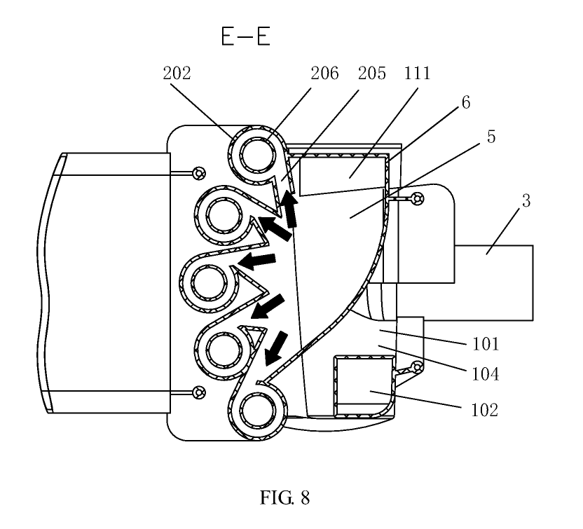

The first embodiment of the invention is as shown in FIGS. 1-8. A dust separating device of a vacuum cleaner comprises a first dust separator 1 and a second dust separator 2 located below and downstream from the first dust separator 1. Preferably, the axis of the first separating unit 101 of the first dust separator 1 and the axes of the second separating units 201 of the second dust separator 2 are arranged perpendicularly with each other. Surely said axis and said axes could be arranged with other interval angle which is about 90 degrees and within the scope of 30 to 150 degrees. The first separating unit 101 of the first dust separator 1 communicates with a dust cup 103 via a dust outlet 102. The first separating unit 101 is located outside of the dust cup 103 and arranged horizontally above the dust cup 103 and the second separating units 201 are arranged perpendicularly adjacent to the dust cup 103.

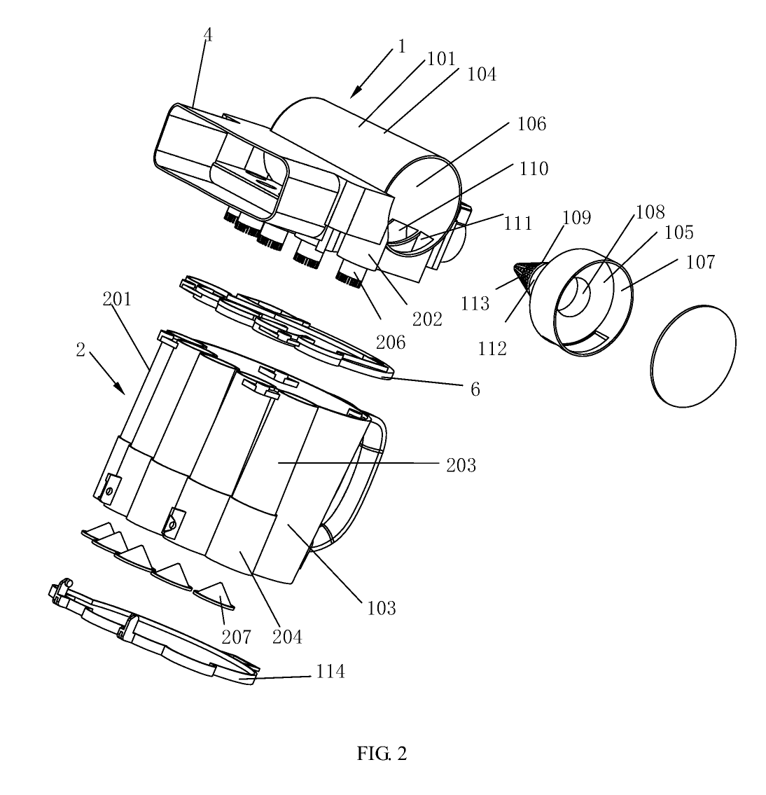

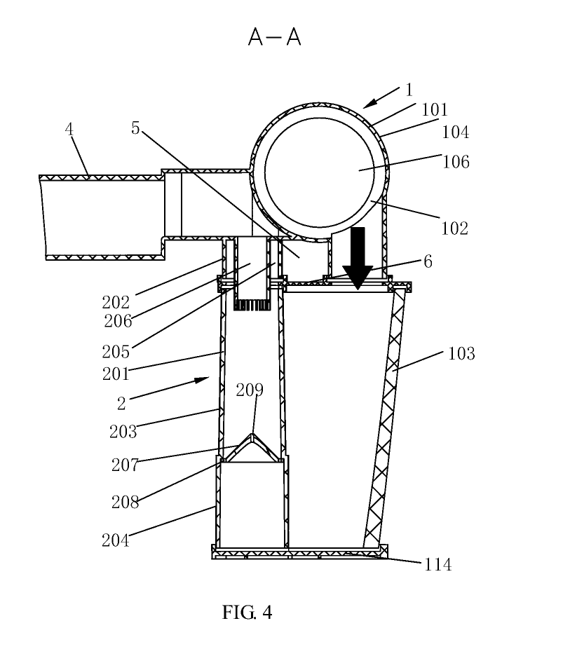

Preferably referring to FIG. 2, in the above mentioned first exemplary embodiment, the first separating unit 101 comprises a cyclone body 104 with a removable cyclone separator 109 provided therein. The cyclone separator 109 has a base plate 105 with an opening 108, a cylindrical portion 112 connected to the opening 108, and a conical filter 113 which is connected to the cylindrical portion 112 and is full of grids. The interior of the cyclone body 104 is divided into a cyclone chamber 106 on the right and a flow chamber 107 on the left by a base plate 105. The cyclone body 104 has a first air inlet 110 connected to an inflow pipe 3 of a vacuum cleaner on the side wall of the cyclone body 104 corresponding to the cyclone separator 109. The cyclone chamber 106 has a dust outlet 102 (shown in FIG. 4) at the right end thereof which is connected to the dust cup 103. The flow chamber 107 has a first air outlet 111 thereon which is connected to the second separating units 201. It should be noted that in the description wording “right” and “left” are used only to describe the relative position relationships, without limitation to their original meanings.

Referring to FIGS. 4-6, each second separating unit 201 comprises an upper portion of cylinder body 202 and a lower portion of conical body 203. The conical body 203 has a dust collector 204 of the second dust separator 2 in the lower portion thereof and each dust collector 204 could be integrated below the corresponding second separating unit. A second air inlet 205 is connected on the side wall of the cylinder body 202 and a second air outlet 206 which is provided coaxially in the cylinder body 202 is connected to an outflow pipe 4 of the vacuum cleaner. An umbrella-shaped reflecting disc 207 is provided in the connecting portion between the conical body 203 and the second dust collector 204. An annular gap 208 is provided along the periphery of said umbrella-shaped reflecting disc 207 to allow falling dust to pass through and the umbrella-shaped reflecting disc 207 defines a hole 209 in the center portion thereof for returning air.

Furthermore, in this embodiment, parts of the outside surface of the second separating units 201 form the periphery of the dust cup 103, and the remain parts of the outside surface form the periphery of said second dust separator 2.

A spacer 6 is arranged between the first separating unit 101 and the second separating units 201, which defines a connecting chamber 5 between the first separating unit 101 and the second separating units 201. The connecting chamber 5 is located below the first separating unit 101 and above the second separating units 201 and the first air outlet 111 is connected to it. The cylinder body 202 protrudes upwardly into the connecting chamber 5 for communicating the second air inlets 205 with the first air outlet 111.

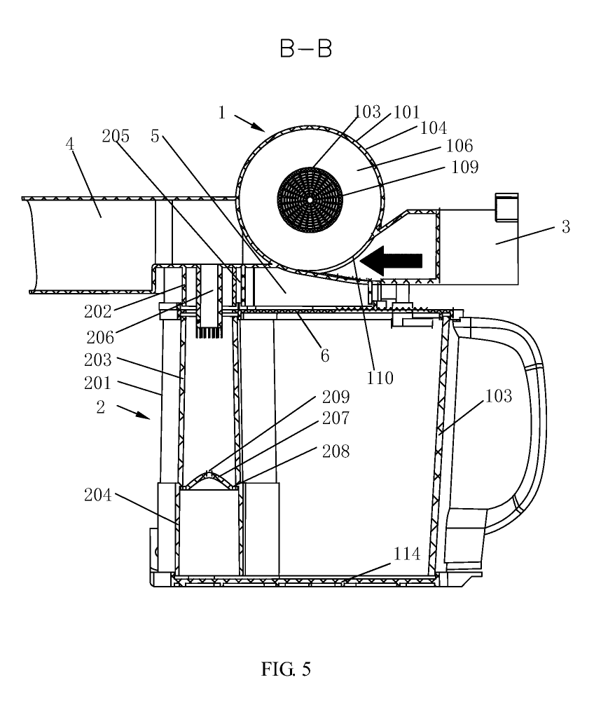

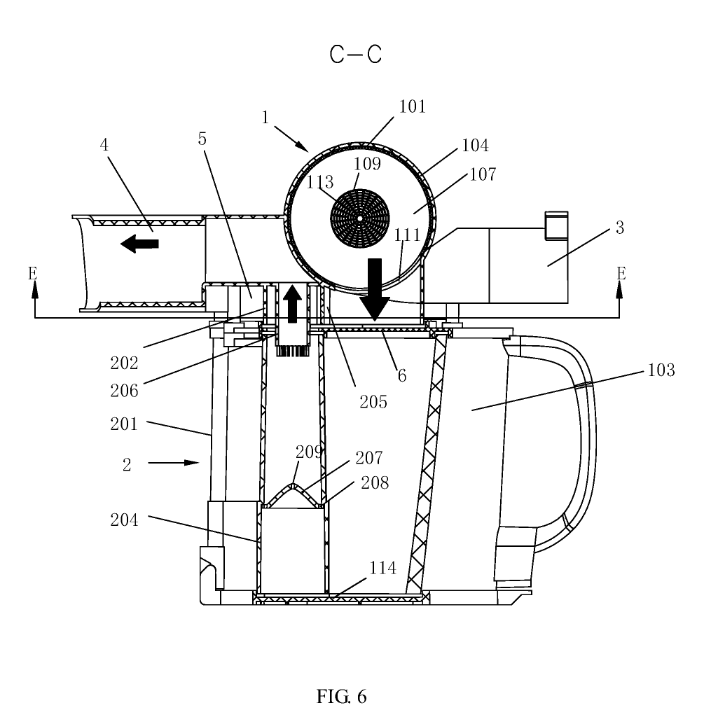

As described above, in this embodiment, the first dust separator 1 closes/opens the opening at one end of the second dust separator 2. The dust separating device further comprises a bottom cover 114 which closes/opens the opening at the other end of the second dust separator 2 so as to concurrently clean up the dust in the dust collector 204 and the dust cup 103. When used, referring to FIG. 5, the dusty air containing dust is introduced from the inflow pipe 3 into the cyclone chamber 106 via the first air inlet 110 of the first separating unit 101. During whirling, coarse dust is introduced into the dust cup 103 through the dust outlet 102 (referring to FIG. 4). While referring to FIGS. 5-6, fine dust follows the air and passes the conical filter 113 of the cyclone separator 109 which is full of small grids, and is introduced into the flow chamber 107 via opening 108, and then into the connecting chamber 5 through the first air outlet 111 of the flow chamber 107, and then into the cylinder body 202 of the second separating units 201 through the second air inlet 205. During whirling, fine dust falls along the inner side wall of the conical body 203 into the dust collector of the second dust collector through the annular gap 208, while the clean air flow is discharged upwardly from the second air outlet 206 through the outflow pipe 4 of the vacuum cleaner.

When dumping dust, if only the bottom cover 114 is opened, the dust in the first dust separator 1 and the second dust separator 2 could be dumped and cleaned up concurrently because that the dust cup 103 of the first dust separator 1 shares the bottom cover 114 with the dust collectors 204 of the second dust separator 2. It gives users more convenience.

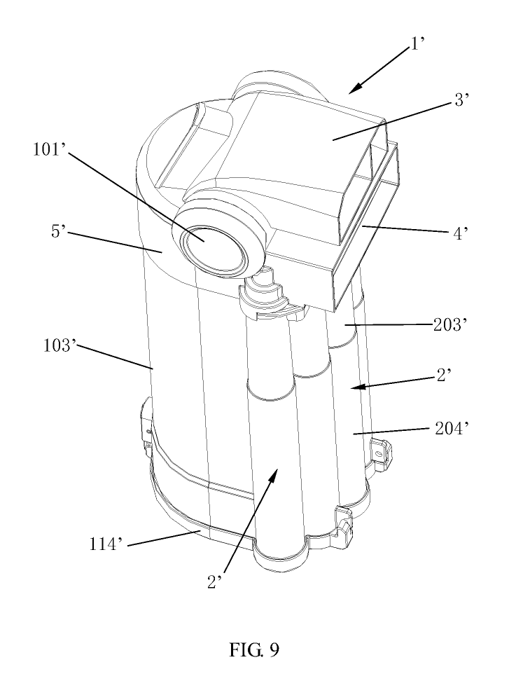

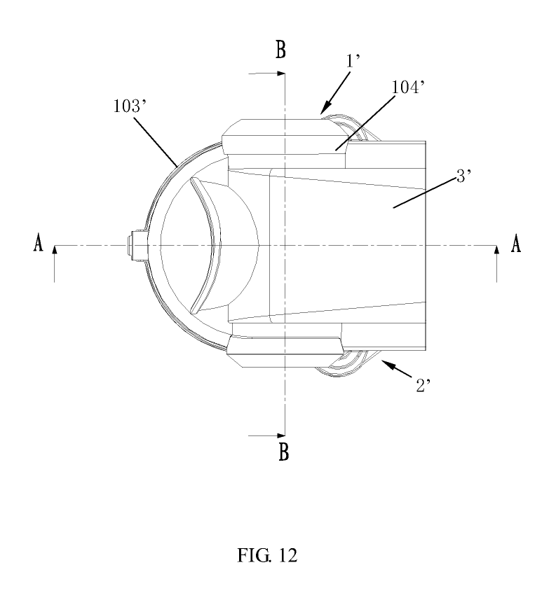

Referring to FIGS. 9-14, hereinafter the second exemplary embodiment of the present invention will be described. The dust separating device in accordance with said embodiment is generally similar to that in accordance with the first exemplary embodiment in most structure and the dedusting principle except for parts of the structure e.g. the positions of the inflow pipe and the outflow pipe, and the relationship between the horizontal length of the first dust separator and the perpendicular height of the second dust separator.

Referring to FIGS. 9-14, a detailed description of a dust separating device of a vacuum cleaner in accordance with the second exemplary embodiment will be provided hereinafter. As shown in FIG. 9, the dust separating device comprises a first dust separator 1′ and a plurality of second dust separators 2′ arranged in parallel and below the first dust separator 1′, with the cyclone axis of the first dust separator 1′ perpendicular to the cyclone axes the second dust separators 2′. The inflow pipe 3′ of the first dust separator 1′ for introducing dusty air flow is located above the outflow pipe 4′ of said a plurality of second dust separators 2′ for discharging air flow dedusted and separated by the first and second dust separators and both pipes 3′, 4′ are arranged at the same side of the first separating unit 101′.

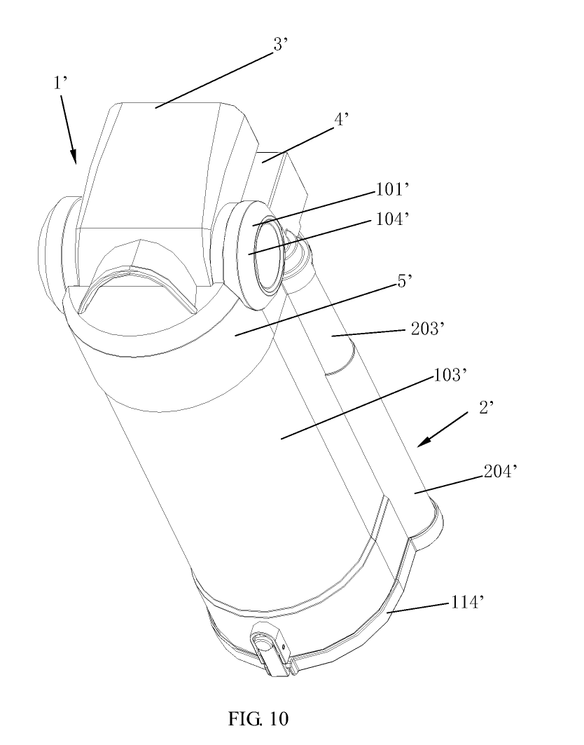

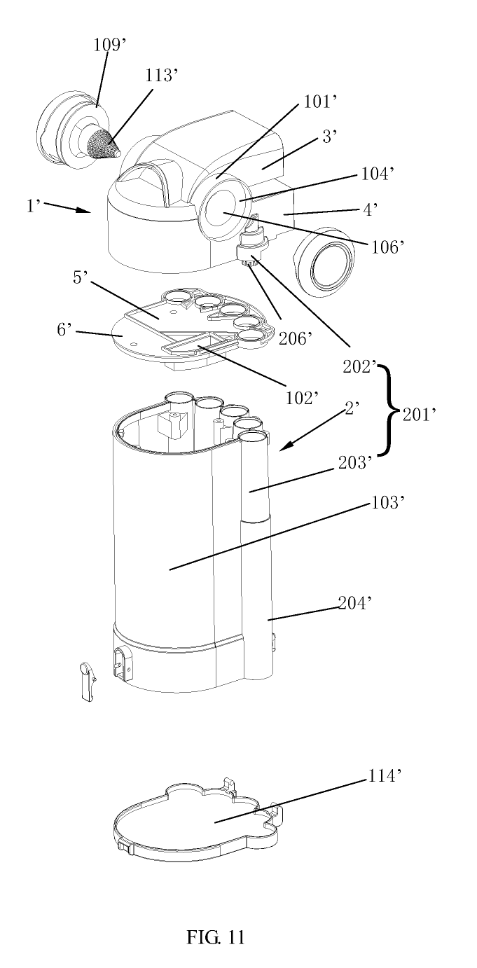

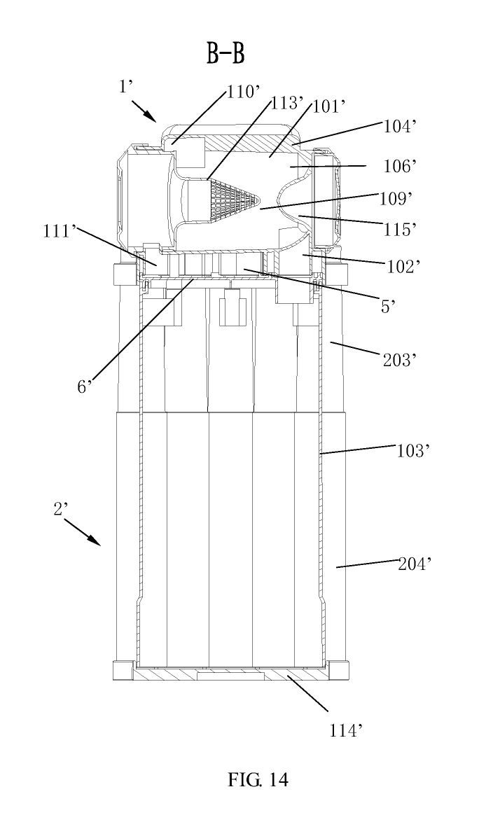

Referring to FIG. 10 combined with FIGS. 11-14, the cyclone body 104′ of the first separating unit 101′ of the first dust separator 1′ is located in an upper portion and the dust cup 103′ is located in a lower portion. The axis of the cyclone body 104′ is perpendicular to the axis of the dust cup 103″. A plurality of the second dust separators 2′ are arranged adjacent to the dust cup 103′ in parallel, while the dust cup 103′ shares a common bottom cover 114′ with the dust collectors 204′ of the second′ dust separators 2′. A connecting chamber 5′ of the second dust separator 2′ i.e. the connecting chamber 5′ between the first separating unit 101′ and the second separating unit 201′ is provided between the first cyclone body 104′ and the top cover ′ of the dust cup 103′ i.e. clapboard 6′. Preferably referring to FIG. 14, a first air inlet 110′ which is connected to the inflow pipe 3′ is provided above the middle portion of the first cyclone body 104″. A cyclone separator 109′ which has a conical filter 113′ and protrudes forwardly is arranged at the rear end of the cyclone body 104′. The interior of the cyclone body 104′ is divided into a cyclone chamber 106′ on the right and a flow chamber 107′ on the left by the cyclone separator 109′. A first air outlet 111′ is provided at the bottom side wall in the conical filter 113′ for connection to the connecting chamber 5′ of the second dust separator 2′. A dust outlet 102′ which is provided in the lower portion of the front end of the cyclone body 104′ communicates with the dust cup 103′ downward through the connecting chamber 5′ of the second dust separator 2′. A cone 115′ extending rearwards is arranged at the front end of the cyclone body 104′ for facilitating the cyclone.

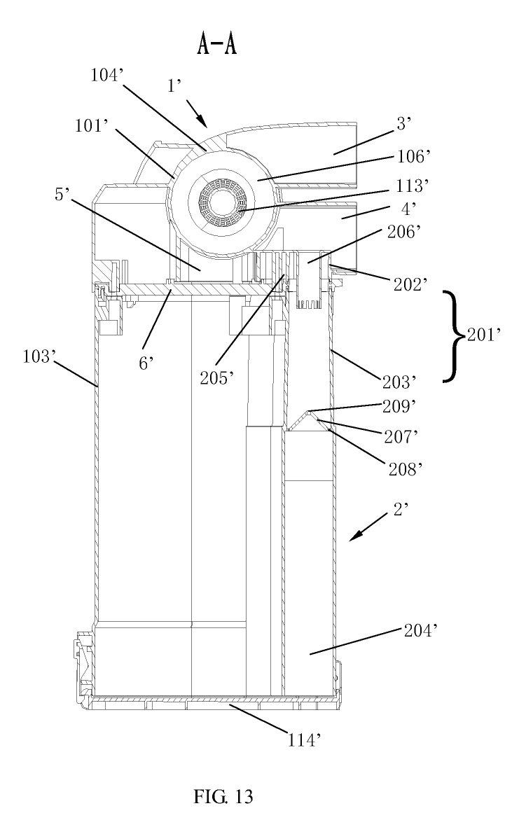

Referring to FIG. 13, the structure of the second dust separator 2′ is similar to that of the second dust separator 2 of the first exemplary embodiment. It also comprises a second separating unit 201′ composed of a cylinder body 202′ in the upper portion and a conical body 203′ in the middle portion, and a dust collector 204′ in the lower portion. The cylinder body 202′ protrudes upward into the connecting chamber 5′. A second air inlet 205′ is provided on the side wall of the cylinder body 202′ in the connecting chamber 5′. A second air outlet 206′ is provided coaxially in the cylinder body 202′, whose top end is connected to the outflow pipe 4′ located below the second air outlet 206′. An umbrella-shaped reflecting disc 207′ is provided in the connecting portion between the conical body 203′ and the dust collector 204′. An annular gap 208′ is provided along the periphery of said umbrella-shaped shield 207′ to allow falling dust to pass through and the umbrella-shaped reflecting disc 207′ defines a hole 209′ in the center portion thereof for returning air.

Referring to FIG. 14 combined with FIG. 13, when used, the dusty air flow containing dust is introduced from the inflow pipe 3′ into the cyclone body 104′ of the first dust separator 1′ via the first air inlet 110′. During whirling, coarse dust is introduced into the dust cup 103′ through the dust outlet 102′. Fine dust follows with the air flow and passes the conical filter 113′ and the air outlet 111′, then is introduced into the connecting chamber 5′. Then it is introduced into each second dust separator 2′ through each second air inlet 205′, thereby forming the cyclone in the cylinder body 202′. During whirling, fine dust falls along the inner side wall of the conical body 203′, and then is introduced into the dust collector 204′ through annular gap 208′. The clean air is introduced upwards through the second air outlet 206′ into the outflow pipe 4′ and finally is discharged therefrom. As for the dumping dust operation, please refer to the above mentioned first exemplary embodiment.

It should be noted that when the dust separating device of this invention is applied into a canister vacuum cleaner e.g. the vacuum cleaner in accordance with the first embodiment, because that the space is limited in the vertical direction and isn't limited in the horizontal direction, the horizontal length of the abovementioned first dust separator 1 is preferably larger than the vertical height of the second dust separator 2, for improving the dedusting efficiency of the first dust separator as much as possible and reducing the burden of the second dust separator, thereby to improve the dedusting efficiency of the whole dust separating device. Otherwise when the dust separating device of this invention is applied into a upright vacuum cleaner e.g. the vacuum cleaner in accordance with the second embodiment, because that the space isn't limited in the vertical direction and is limited in the horizontal direction, the horizontal length of the abovementioned first dust separator 1′ is preferably smaller than the vertical height of the second dust separator 2′, thereby improving the dedusting efficiency of the whole dust separating device by improving the dedusting efficiency of the second dust separator.

Additionally, as for the closing/opening function of the first dust separator to the second dust separator, it should be understood that the first dust separator closes/opens the top opening of the second dust separator, while the bottom cover closes/opens the bottom opening of the second dust separator. Therefore, the dust in the second dust separator could be cleaned up by opening the top opening of the second dust separator, as well as by opening the bottom opening. This is particularly convenient to wash the second dust separator by water.

When the preferred embodiment of the present invention has been set forth in the foregoing description and accompanying drawings, it could be envisaged that modifications and variations which are different from the embodiments will occur to a skilled person in the art, and they should not be excluded from the scope and spirit of the appended claims.

1-20. (canceled)

21. A dust separating device of a vacuum cleaner comprising:
a first dust separator including a first separating unit;
a second dust separator located downstream from the first dust separator and comprising a plurality of second separating units generally parallel to each other, positioned with a predetermined angle between the axis of the first separating unit of said first dust separator and the axes of said second separating units of the second dust separator; and
a dust cup for collecting dust separated by the first separating unit, wherein the dust cup is connected via a dust outlet to the first separating unit of said first dust separator, and wherein said first separating unit is located above said dust cup, and wherein said second separating units are located adjacent to said dust cup.

22. The dust separating device of a vacuum cleaner according to claim 21, wherein said first separating unit comprises a cyclone body, whose interior is divided into a cyclone chamber on a first end and a flow chamber on a second end by a removable cyclone separator, said cyclone separator having an opening on the first end and a conical filter full of grids on the second end which is positioned in said cyclone chamber, and wherein a first air inlet is connected to an inflow pipe of the vacuum cleaner and is provided on the side wall of the cyclone body corresponding to the conical filter, and wherein said dust outlet is connected to the dust cup and located on the first end of said cyclone chamber, and wherein a first air outlet is connected to the second separating units and is provided on the flow chamber.

22. The dust separating device of a vacuum cleaner according to claim 21, wherein said first separating unit comprises a cyclone body, whose interior is divided into a cyclone chamber on the first end and an flow chamber on the second end by a removable cyclone separator, wherein said cyclone separator has an opening on the first end thereof and a conical filter full of grids on the second end thereof which is positioned in said cyclone chamber, and wherein a first air inlet is connected to an inflow pipe of the vacuum cleaner and is provided on the side wall of the cyclone body corresponding to the conical filter, and wherein said dust outlet is connected to the dust cup and is provided on the first end of said cyclone chamber, and wherein a first air outlet connected to the second separating units is provided on the flow chamber.

23. The dust separating device of a vacuum cleaner according to claim 22, wherein each said second separating unit comprises an upper portion with a cylinder body and a lower portion with a conical body; and wherein a second dust collector of the second dust separator is arranged below said conical body; and wherein a second air inlet is connected to the side wall of the cylinder body; and wherein a second air outlet is provided substantially coaxially in said cylinder body and is connected to an outflow pipe, and wherein an umbrella-shaped reflecting disc is provided in the connecting portion of the conical body and the second dust collector, and wherein an annular gap for allowing falling dust to pass therethrough is provided along the periphery of said umbrella-shaped reflecting disc, and wherein the umbrella-shaped reflecting disc defines a hole for returning air in the center portion thereof.

24. The dust separating device of a vacuum cleaner according to claim 22, wherein a connecting chamber is provided between the first separating unit and the second separating units, wherein said connecting chamber is located below said first separating unit and above the second separating units, and wherein said first air outlet is connected to said connecting chamber, and wherein said cylinder body protrudes upward into the connecting chamber, thereby communicating the second air inlets with said first air outlet.

25. The dust separating device of a vacuum cleaner according to claim 23, wherein said first dust separator further comprises an inflow pipe which is located at one end thereof and is connected to said first air inlet; and wherein the outflow pipe is located at the other end of said first dust separator and is for discharging air flow which has been dedusted and separated by the first and second dust separators, and wherein said second air outlets are located below the dust separator and inserted into the corresponding second separating units as well as connected to said outflow pipe.

26. The dust separating device of a vacuum cleaner according to claim 21, wherein the horizontal length of said first dust separator is larger than the vertical height of said second dust separator.

27. A dust separating device of a vacuum cleaner comprising:
a first dust separator including a first separating unit,
a second dust separator located downstream from the first dust separator and including a plurality of second separating units generally parallel to each other; and
a dust cup for collecting dust separated by the first separating unit, wherein the first separating unit is connected to said dust cup via a dust outlet, and wherein said first separating unit is located above said dust cup and arranged in a first direction, and wherein each second separating units is arranged in a second direction.

28. The dust separating device of a vacuum cleaner according to claim 27, wherein the horizontal length of said first dust separator is smaller than the vertical height of said second dust separator.

29. The dust separating device of a vacuum cleaner according to claim 28, wherein said first separating unit is arranged with a predetermined angle between said first direction and said second direction.

30. The dust separating device of a vacuum cleaner according to claim 27, wherein said first dust separator comprises an inflow pipe for introducing dusty air flow and an outflow pipe for discharging air flow which has been dedusted and separated by the first and second dust separators.

31. The dust separating device of a vacuum cleaner according to claim 30, wherein said inflow pipe is located above said outflow pipe, and both pipes are arranged at the same side of the first separating unit.

32. A vacuum cleaner comprising:
a first dust separator comprising a first separating unit;
a second dust separator with its two ends open and located downstream from said first dust separator, wherein said second dust separator comprises a plurality of second separating units at least partially parallel to each other;
a plurality of second dust collectors arranged corresponding to respective second separating units; and
a dust cup for collecting dust separated by the first separating unit;
a spacer located between said first dust separator and said second dust separator for dividing the air flow out from said first dust separator into a plurality of small flows to be introduced into the corresponding second separating units; and
wherein said first dust separator is removably located above said second dust separator, and wherein said first dust separator closes/opens the opening at one end of the second dust separator.

33. The vacuum cleaner according to claim 32, further comprising a bottom cover for closing/opening the opening at the other end of said second dust separator so that the dust in said dust collectors and said dust cup could be cleaned up simultaneously.

34. The vacuum cleaner according to claim 33, wherein parts of the outside surface of the second separating units form the periphery of said dust cup, and the remaining parts of the outside surface form the periphery of said second dust separator.

35. The vacuum cleaner according to claim 34, wherein each dust collector is integrated below the corresponding second separating unit.

36. The vacuum cleaner according to claim 32, wherein said first dust separator further comprises: a first air inlet communicating with the first separating unit at one end thereof, a first air outlet adjacent to the first air inlet, a dust outlet connected to the first separating unit at the other end thereof, and a connecting chamber connected to said first air outlet.

37. The vacuum cleaner according to claim 36, wherein said first separating unit comprises a cyclone body, whose interior is divided into a cyclone chamber on a first end and an flow chamber on a second end by a removable cyclone separator, wherein said cyclone separator has an opening on the first end thereof and a conical filter full of grids on the second end thereof which is positioned in said cyclone chamber.

38. The vacuum cleaner according to claim 37, wherein the first air inlet connected to an inflow pipe of the vacuum cleaner is provided on the side wall of the cyclone body corresponding to the conical filter, and wherein said dust outlet connected to the dust cup is provided on the first end of said cyclone chamber, and wherein the first air outlet connected to the second separating units is provided on the flow chamber.

39. The vacuum cleaner according to claim 32, wherein the horizontal length of said first dust separator is smaller than the vertical height of said second dust separator.

40. The vacuum cleaner according to claim 32, wherein the horizontal length of said first dust separator is larger than the vertical height of said second dust separator.
